(19) United States
(12) Patent Application Publication
(10) Pub. No.: US 2021/0130134 A1
(43) Pub. Date: May 6, 2021

(54) METHODS OF TREATING A LOAD-BEARING PART IN A PASSENGER MOVING SYSTEM

(71) Applicant: thyssenkrupp Elevator Innovation and Operations GmbH

(72) Inventor: Michael Palazzola, Horn Lake, MS (US)

(73) Assignee: thyssenkrupp Elevator Innovation and Operations GmbH, Essen (DE)

(21) Appl. No.: 16/669,026

(22) Filed: Oct. 30, 2019

(51) Int. Cl. B66B 11/02; B66B 7/08; B29D 29/10

(52) U.S. Cl. CPC B66B 11/0226; B29D 29/103; B66B 7/085

(57) ABSTRACT

Methods are disclosed of treating a load-bearing part in a passenger moving system. The load-bearing part includes a plurality of tension members surrounded by a polymer material, wherein the load-bearing part includes a plurality of sections. At least one of the sections is configured to be inserted into an end termination. The methods include selecting at least one section of the load bearing part. At least a part of the polymer material at the at least one section is removed to expose the plurality of tension members. A conductive layer is applied to the exposed tension members to obtain a connection terminal. The connection terminal is connected to a monitor. The end termination is connected to the monitor.

### FIELD

The invention relates to methods of treating or forming a load-bearing part in a passenger moving system, the load-bearing part comprising a plurality of tension members surrounded by a polymer material wherein the load-bearing part comprises a plurality of sections, at least one of which is inserted into an end termination.

### BACKGROUND

All passenger moving systems, including elevators, escalators and moving walks are required by law to adhere to strict safety regulations in order to ensure passenger safety. Monitoring the condition of the various component parts forms part of the every-day operation and maintenance of such systems. In elevator systems for example, monitoring the condition of a load-bearing part, e.g., a belt, is of vital importance. The normal orientation of a load-bearing part involves attaching it at one end to a load, normally the elevator cabin, attaching it at the other end to a counterweight and positioning the load-bearing part such that it travels along a sheave and pulley system to raise and lower the elevator cabin. Such a load-bearing part is comprised within an end termination at either one or both ends, wherein both ends allows for end to end belt monitoring capability.

Various methods of monitoring the condition of a load-bearing part exist. EP 3495304 A1 discloses a method of health monitoring of a belt of an elevator. The belt comprises a plurality of tension members having a metallized coating layer. A voltage is applied across the metalized coating in order to evaluate one or more electrical properties thus indicating the health of the belt.

US 2019/0119071 A1 discloses an elevator belt pressure monitoring system that monitors the entire length of the elevator belt including the portion of the elevator belt held in the end termination. To achieve this, the end termination includes a wedge housing with a segmented wedge disposed axially within the housing wherein the segmented wedge includes at least two wedge members spaced apart from one another to define a space there between, at least one pressure sensor disposed in the space, wherein the at least one pressure sensor registers compressive pressure exerted between the at least two wedge members.

However, the art fails to teach how to monitor the health and condition of the section of the load-bearing part that is comprised in an end termination. There is a need, therefore, to provide a solution to this problem.

The need is satisfied by methods and according to the load-bearing part disclosed herein.

### SUMMARY

The invention relates to a method of treating a load-bearing part in a passenger moving system wherein the passenger moving system is an elevator, an escalator or a moving walk, for example. A typical elevator system may include an elevator car and counterweight movable within an elevator shaft using a plurality of load-bearing parts that hoist and/or lower the elevator car. In one example, an elevator system includes four load-bearing parts configured to move the elevator car and counterweight within the elevator shaft. Each end of each load-bearing part may be held in a separate end termination held on another component of the elevator system. The other component of the elevator system may be one or more of the elevator car, a support beam or structure of the elevator car and/or counterweight, a portion of the elevator shaft, or the counterweight. A motor arrangement may be configured to drive the load-bearing part to lift and lower the elevator car.

The load-bearing part may be a rope or a plurality of ropes, or a belt or a plurality of belts, wherein the rope(s) or belt(s) have a cross-section according to those known in the art. The rope(s) or belt may comprise a plurality of tension members comprised in a polymer material. The term “comprised in” is preferably interpreted broadly and can refer for example to any one of “surrounded by”, “embedded”, “laminated”, “covered”, “coated”, “enveloped”, “encased”, or “mixed with,” among others. The term “polymer material” may refer to any known polymer material in the art which can be used for these purposes. The tension members may comprise a conductive material, e.g., steel fibers, or conductive carbon fibers. The polymer material may have a low conductivity, and preferably is electrically non-conductive.

The load-bearing part comprises a plurality of sections at least one of which is inserted into an end termination. The end termination may comprise a housing, at least one end termination rib, and a wedge.

The method, in one example, comprises the steps of:
a) selecting at least one section of the load bearing part, preferably a section that is not comprised within an end termination because then it is more easily accessible for treatment, preferably a section that comprises a terminal end of the load-bearing part, most preferably a terminal end of the load-bearing part which is not comprised within an end termination because then it is more easily accessible for treatment. It is also possible that the terminal end can be treated when at least one other section of the load-bearing part is already comprised within an end termination;
b) optionally removing at least a part of the polymer material at the at least one section to expose a plurality of tension members. Removal of the polymer material preferably depends on the type of conductive layer to be applied. In some instances, removal of polymer material is not required.
c) applying a conductive layer to the exposed plurality of tension members to obtain a connection terminal. The conductive layer can be a layer of metal material, preferably melted metal material, or a layer of a conductive piece of material, for example a layer of a conductive strip, wherein said conductive strip is preferably commercially available. An example of such a strip is known as a “Zebra strip”.

### Melted Metal Approach

In this approach, a part of the at least one section of the load-bearing part, preferably a section comprising a terminal end, preferably a terminal end that is not attached to an elevator cabin, or is not intended to be attached to an elevator cabin, is immersed in a concentration of melted metal. The metal may be a low melting point metal or a low melting point metal alloy; examples of such metals include; bismuth, tin, lead, cadmium, indium, zinc, thallium, wherein preferred metal alloys comprises one or more of these metals. These metals can be combined with other elements of the periodic table according to desired physical and chemical characteristics. The melted metal may be at a temperature that allows it to melt off the polymer material, thus exposing the plurality of tension members comprised therein. Preferably, the amount of polymer material removed is sufficient to expose at least the terminal ends of the plurality of tension members. In this example, it is possible that polymer material along the length of the tension members will also be removed when immersed in the melted metal. Any polymer material removed however, will be replaced by the melted metal with the goal that all exposed tension members are completely covered. The melted metal surrounds the tension members, the immersed part is then removed from the metal concentration and exposed to the atmosphere allowing the melted metal to solidify. This process interconnects or “shorts out” the tension members in one step and provides a single point of connection for any external connector thereto, preferably a conductor, e.g., a wire.

### Conductive Strip Approach

In this approach, there is no need to remove any polymer material from the load-bearing part, provided that the plurality of tension members are directly exposed at one or more of the terminal ends. It is however possible to manually remove a section of the polymer material e.g., using suitable wire strippers, in order to expose a greater surface area of the plurality of tension members should this be desired. In one example, only enough polymer material is removed so that the terminal ends of the tension members are exposed, i.e., little to no polymer material is removed from along the length of the tension members. A strip of conductive material is applied to the exposed ends of the tension members. Such a strip needs only to contact the exposed ends of the tension members in order to electrically interconnect or “short out” all tension members. The strip preferably comprises silicon. Such a strip is commercially available.

The method comprises the steps of:
d) connecting the connection terminal to a monitor. The monitor preferably monitors capacitance. However, it is envisioned that other monitoring devices can be used instead.
e) connecting the end termination to the monitor. Preferably, the end termination and the connection terminal on the load-bearing part are connected to the same monitor.

In one example, a first end of a first electrical connector is attached to the connection terminal, preferably a conductive wire. Attachment may be carried out using a solder or other means of securely and conductively connecting a wire to a connection terminal, i.e., the interconnected tension members.

The method can advantageously be applied to a load-bearing part already comprised in an end termination, or it can be applied to a load-bearing part that is separate from an end termination, wherein the load-bearing part, once treated according to the method, is then inserted into the end termination. The load-bearing part may be inserted into the end termination such that the treated section is the free section of the load-bearing part that exits the end termination. If the treated section touches the termination, it will short out the capacitance reading.

In another example, a second end of the first electrical connector is attached to the monitor; preferably a first end of a second electrical connector is attached to the end termination, preferably the housing of the end termination; preferably a second end of the second electrical connector is attached to the monitor.

This method advantageously provides a load-bearing part having a plurality of sections wherein the section that is comprised within the end termination is configured for condition monitoring. This method provides an “end-to-end” belt solution, which means that the condition of the load-bearing part can be controlled at the end termination, and if necessary, only at the end termination. This advantageously removes the need to further control the load-bearing part at any other location. If any change in capacitance occurs in the end termination, e.g., if the load increases, the capacitance will increase accordingly. The amount of capacitance ultimately depends on the number of tension members comprised within the load-bearing part. Furthermore, it advantageously provides a solution to monitoring the condition of the belt, without having to modify the internal components of the end termination.

In an example of the invention, the connection terminal may be obtained by immersing the at least one section into a concentration of melted metal. This simultaneously removes the polymer material by melting it and then applies the conductive layer to the exposed tension members. This advantageously provides a “one pot process” to obtain a connection terminal. The immersed section is then removed to obtain the connection terminal. This advantageously provides a quick and easy way to obtain a connection terminal on a load-bearing part.

In an example of the invention, the connection terminal may be obtained by manually removing the polymer material to expose the tension members. This can be done using wire strippers or other suitable equipment. A conductive layer is applied to the exposed tension members. The conductive layer is preferably in the form of a conductive strip. This advantageously provides a quick and easy way to obtain a connection terminal on a load-bearing part.

In an example of the invention, the connection terminal may be located at a terminal end of the load-bearing part, wherein the terminal end is a free end of the load bearing part that is disposed outside of the end termination and does not bear the load of the elevator cabin or counterweight. This advantageously provides for a way of monitoring the condition of the load-bearing part inside an end termination without causing any “short outs” within the end termination.

In an example of the invention, the monitor may be configured to measure capacitance. This advantageously provides a way of monitoring the change in capacitance inside the end termination.

In an example of the invention, the tension members may comprise a conductive material. The tension members may comprise a plurality of fibers, wherein said fibers comprise any suitable material known in the art for such purposes. An example of possible fiber material includes steel, conductive carbon, or conductive carbon nanotube fibers, or any combination thereof. This advantageously provides a load-bearing part that can be integrated into an electrical circuit.

In an example of the invention, the polymer material may have a low electrical conductivity. This advantageously provides a load-bearing part that can be integrated into an electrical circuit.

In an example of the invention, the load-bearing part may be comprised within an end termination before treatment begins.

In an example of the invention, the load-bearing part may be first treated and then introduced to an end termination.

The invention further relates to a load-bearing part obtained from the method according to any of the preceding examples. This advantageously provides a load-bearing part that is adapted for simplified condition monitoring, i.e., where the condition of the load-bearing part can be monitored directly at the end termination.

The invention also relates to a use of a load-bearing part in a passenger moving system, preferably an elevator system, wherein the load-bearing part is obtained from the method according to any of the preceding examples or is a load-bearing part according to the previous example. This advantageously provides a way to simplify condition monitoring of a load-bearing part in passenger moving systems. The passenger moving system may also comprise an escalator or a moving walk.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a schematic step diagram of a method according to the invention.

FIG. 2 is a schematic representation of an end termination comprising a load-bearing part, wherein the load-bearing part has been treated according to a method of the invention.

FIGS. 3a to 3d are a load-bearing part treated according to a method of the invention and the stages involved when introducing it to an end termination.

FIG. 4 is a schematic of how an electrical circuit is established between a load-bearing part and an end termination.

FIGS. 5a and 5b are schematic views of a method according to the invention.

FIGS. 6a to 6c are schematic views of a method according to the invention.

### DETAILED DESCRIPTION

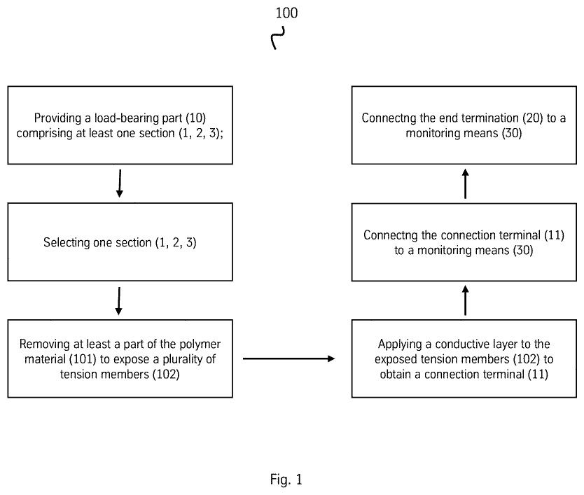

FIG. 1 depicts a step diagram of a method 100 according to the invention. First a load-bearing part 10 comprising at least one section 1, 2, 3, is provided. The load bearing part 10 can be attached to an elevator cabin (not shown), counterweight, or hoistway wall, or hoistway ceiling at this stage, or it may be attached to an elevator cabin, counterweight, or hoistway wall, or hoistway ceiling at a later stage, e.g. after the method steps have been performed. The second step involves selecting at least one part of the load-bearing part to treat according to the inventive method. The at least one part may comprise a terminal end, wherein the terminal end is a free end of the load bearing part 10 that is disposed outside of an end termination 20 and does not bear the load of the elevator cabin or counterweight.

The third step involves the removal of the polymer material 101 surrounding the plurality of tension members 102. This can be carried out in one of two ways, i.e., via immersion in a melted metal, or via manual removal using e.g., wire strippers.

The next step is the application of a conductive layer to the exposed tension members. This step may be carried out either via the melted metal method, or the conductive strip method.

The conductive layer forms a connection terminal 11. When the conductive layer is applied via the melted metal method, it may not be possible to immediately connect the connection terminal 11 to a monitor 30. The metal layer may need time to solidify. When the conductive layer is applied via the conductive strip method, the connection terminal 11 is immediately ready for connection to a monitor 30. The monitor in this example monitors capacitance.

As a final step, the end termination 200 itself may be connected to the monitor 30. The end termination 200 is electrically connected to the monitor 30 in order to allow for condition monitoring of the load-bearing part 10 whilst comprised therein. This connection may be achieved by for example, drilling a hole into the housing 20 and introducing the electrical connector 320 thereto at the electrical connection point 21. Alternatively, the housing 20 may already be comprised of a material that permits electrical conductivity, in which case, all that is required is connection of the connector 320 to the electrical connection point 21. The connection can be in the form of a conductive glue or solder, for example.

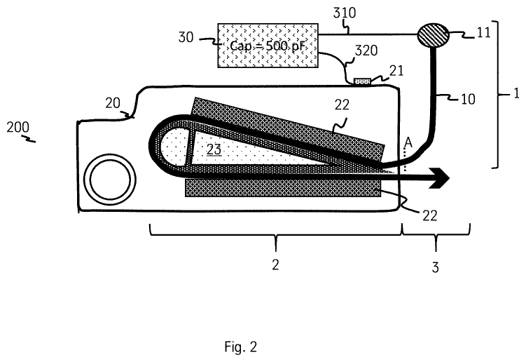

FIG. 2 shows a schematic representation of a load-bearing part 10 having been treated according to a method of the invention. In this particular example, the load-bearing part 10 is treated according to a method of the invention when already in place in an elevator system, i.e., it is already comprised in the end termination 200 and the end represented by the arrow is connected to the elevator cabin.

FIG. 2 shows more clearly the different sections 1, 2, 3 of the load-bearing part. Section 1 refers to the load-bearing part 10 that comprises a terminal end, wherein this terminal end is not connected to a load, e.g., an elevator cabin. This terminal end undergoes a method of treatment according to the invention and comprises a connection terminal 11, wherein said connection terminal 11 is connected to a monitor 30 via an electrical connector 310. Section 1 starts at the connection terminal 11 and continues in the direction of the end termination 200 until point A, i.e., at the point when the load-bearing part 10 enters the end termination 200. The monitor in this example monitors capacitance.

Section 2 refers to the load-bearing part 10 that is comprised within the end termination 200. The end termination 200 comprises a housing 20, an electrical connection 21 comprised thereon, a first end termination rib 22, a second end termination rib 22, and a wedge 23. The electrical connection 21 ensures that the metal of the end termination is electrically connected with the monitor 30.

The load-bearing part 10 in section 2 is disposed between a first end termination rib 22 and a second end termination rib 22, having a wedge 23 located therebetween in order to hold the load-bearing part 10 in place.

Section 3 refers to the load-bearing part 10 that exits the end termination 200 and is attached to a load, e.g., an elevator cabin. The load is represented by an arrow.

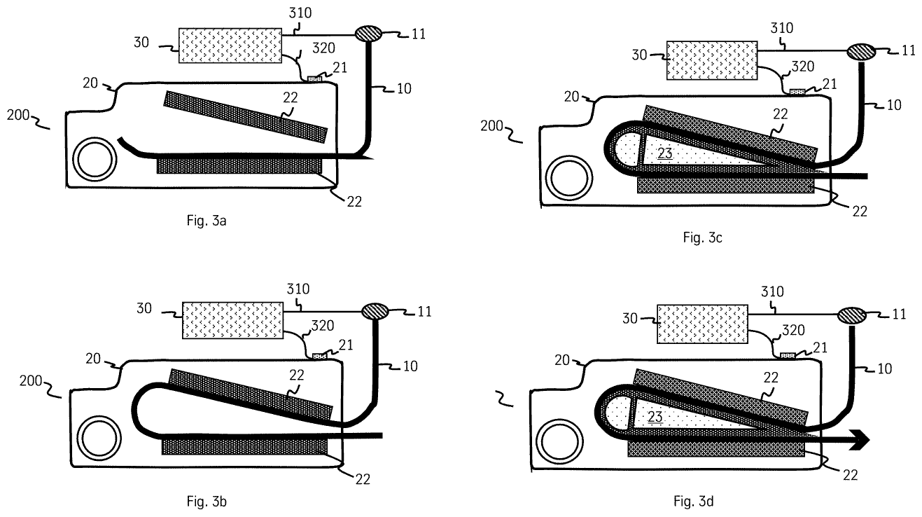

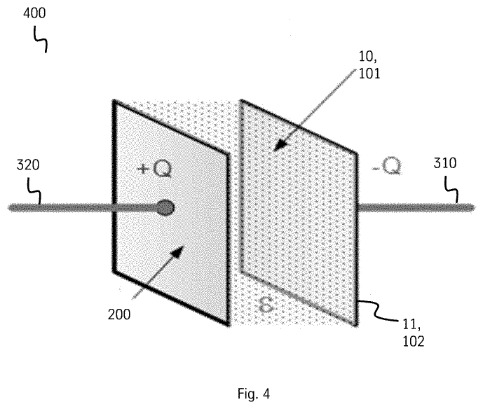

FIGS. 3a to 3c depict a load-bearing member 10 after having been treated according to a method of the invention. The load-bearing part 10 is then introduced to an end termination 200, in particular, to the housing 20. The housing 20 is itself connected to the monitor 30. This establishes a circuit between the tension members 102 which are coated with the conductive layer and form the connection terminal 11 and the end termination 200 which means that the monitor 30 can monitor any changes in capacitance inside the end termination 200, in particular, inside the end termination housing 20. This is explained in more detail in FIG. 4.

In FIG. 3a, the load-bearing part 10 is only partially disposed in the end termination housing 20 and contacts a first end termination rib 22. In this example, the load-bearing part 10 is exposed to relatively little stress, therefore the monitor 30 measures a capacitance in the range of 50 to 200 picofarads (pF). This value is given purely for illustrative purposes since the capacitance will change depending on the number of tension members present. The fewer the tension members, the lesser the capacitance. All capacitance measurements should be taken with the passenger moving system in a stationary position due to the fact that there is a build-up of charge on the belt during movement. This can cause inaccurate and erroneous readings.

In FIG. 3b, the load-bearing part 10 forms a loop within the end termination housing 20 and contacts a first end termination rib 22 and a second end termination rib 22. This looped configuration increases the internal stress within the load-bearing part 10 causing the monitor 30 to measure a higher capacitance in the range of 200 to 450 pF. This value is given purely for illustrative purposes since the capacitance will change depending on the number of tension members present. The fewer the tension members, the lesser the capacitance.

In FIG. 3c, a wedge 23 is positioned between the looped section of the load-bearing part 10. This increases the internal stress within the load-bearing part 10 even more, causing the monitor 30 to measure an even higher capacitance in the range of 450 to 1000 pF. This value is given purely for illustrative purposes since the capacitance will change depending on the number of tension members present. The fewer the tension members, the lesser the capacitance.

In FIG. 3d, the load bearing part 10 has a load attached to the remaining terminal end, i.e., the terminal end which was not treated according to a method of the invention. The load is represented by the arrow and in this example is an elevator car. The addition of a load to the load-bearing part 10 causes the internal stress within the load-bearing part 10 to reach a maximum value. This is reflected in the measured capacitance which is in the range of 1000 pF to 3000 pF. This value is given purely for illustrative purposes since the capacitance will change depending on the number of tension members present. The fewer the tension members, the lesser the capacitance.

Knowing the maximum capacitance measured in the load-bearing part 10 allows for a control of any changes therein. In the event the monitor 30 measures a significant change in capacitance, it can be concluded that there is a problem with the load-bearing part and a maintenance operation is required.

FIG. 4 shows how an electrical circuit 400 can be established between an end termination 200 and a load-bearing part 10 having been treated according to a method of the invention. The end termination 200 is connected with the electrical connector 320 at the connection point 21. The end termination 200 is shown as a first plate having the charge (+Q).

The load-bearing part 10 comprises a plurality of tension members 102 in a polymer material 101. At least a section of the load-bearing part 10, wherein in this example the section comprises the terminal end of the load-bearing part 10, has been treated according to a method of the invention. Thus, the terminal end now comprises a connection terminal 11, wherein the connection terminal 11 comprises an exposed plurality of tension members 102 surrounded by a conductive layer. An electrical connector 310 is connected at the connection terminal 11. This is shown as a second plate having the charge (−Q). By connecting the end termination 200 and the load-bearing part 10 at the connection terminal 11, and due to the dielectric nature of the polymer material 101 an electrical circuit is established, thereby allowing for characteristics of said circuit to be monitored, e.g., capacitance.

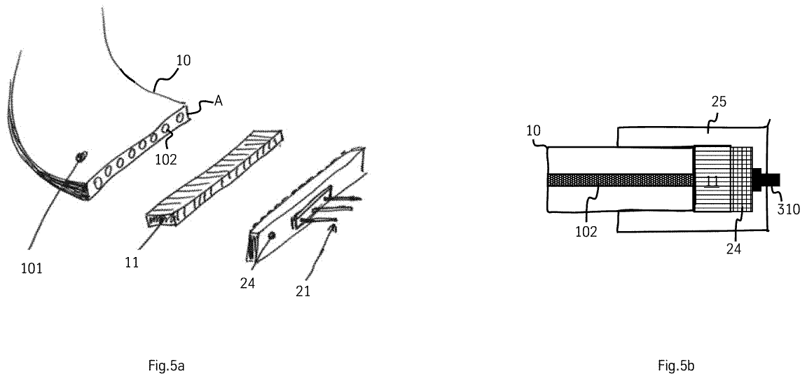

FIG. 5a shows how a load-bearing part 10 can be prepared according to a method of the invention, in particular according to the conductive strip approach. In this particular example, the load-bearing part 10 comprises a plurality of tension members 102 in a polymer material 101. The plurality of tension members 102 are directly exposed at the terminal end, i.e., the length of the polymer material 101 and the length of each tension member 102 is the same such that the exposed part of each tension member lies flush with the end surface A of the polymer material. In this particular example, no preparatory work of the load-bearing part is required. A strip of conductive material 11 is applied to surface A such that it contacts the exposed tension members and electrically interconnects them. This particular strip comprises silicon and is commercially known as a “Zebra connector”. Next, the load-bearing part 10 comprising the zebra connector 11 is contacted with a printed circuit board (PCB) 24 having an electrical connection 21.

FIG. 5b shows a cross-sectional side view of FIG. 5a when the load-bearing part 10 comprising the zebra connector 11, the PCB 24 and electrical connection 21 is comprised within a non-conductive housing 25.

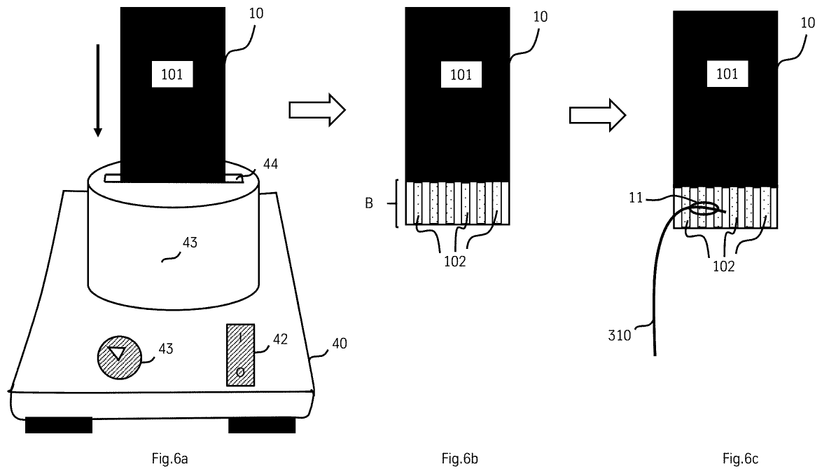

FIGS. 6a to 6c show a load-bearing part 10 prepared according to a method of the invention, in particular according to the melted metal approach. In this particular example, the load-bearing part 10 comprises a plurality of tension members 102 in a polymer material 101. The load-bearing part 10 is introduced to an immersion bath 43 comprising a melted metal at the inlet 44. In this particular example, the metal used is bismuth. The immersion bath 43 is positioned on a hot plate 40 so that the metal is in the melted state throughout the immersion process. In FIG. 6b, the load-bearing part 10 has been stripped of the polymer material 101 at section B and the plurality of tension members 102 is now exposed. As a next step, shown in FIG. 6c, an electrical connection is made between the electrical connector 310 and the exposed tension members 102 by applying a conductive material thereto—in this particular example, a solder is used, thereby forming a connection terminal 11. The connection terminal 11 can be any size, shape, depth, and/or length.

It should be understood that the appended figures are not necessarily to scale and present a simplified representation of various features illustrative of the basic principles of the invention. The specific design features of the present invention, for example, dimensions, orientations, locations and shapes; will be determined by the particular intended application and use environment. Accordingly, the foregoing description is intended to be illustrative rather than restrictive. The assembly of the present disclosure described hereinabove is defined by the claims, and all changes that fall within the meaning and range of equivalency of the claims are to be embraced within their scope.

What is claimed is:

1. A method of treating a load-bearing part in a passenger moving system, the load-bearing part comprising a plurality of tension members surrounded by a polymer material, wherein the load-bearing part comprises a plurality of sections at least one of which is configured to be inserted into an end termination, the method comprising:
selecting at least one section of the load bearing part;
applying a conductive layer to exposed tension members of the at least one section to obtain a connection terminal;
connecting the connection terminal to a monitor; and
connecting the end termination to the monitor.

2. The method of claim 1 further comprising removing at least a part of the polymer material at the at least one section to obtain the exposed tension members.

3. The method of claim 1 wherein the connection terminal is obtained by:
immersing the at least one section into a concentration of melted metal; and
removing the immersed section to obtain the connection terminal.

4. The method of claim 1 wherein the connection terminal is obtained by:
applying a conductive layer to the exposed tension members.

5. The method of claim 1 wherein the connection terminal is located at a terminal end of the load-bearing part, and wherein the terminal end is a free end of the load bearing part that is disposed outside of the end termination.

6. The method of claim 1 wherein the monitor is configured to measure capacitance.

7. The method of claim 1 wherein the tension members comprise an electrically conductive material.

8. The method of claim 1 wherein the polymer material is electrically insulative.

9. The method of claim 1 wherein the load-bearing part is disposed within the end termination.

10. The method of claim 9 wherein the load-bearing part is disposed within the end termination before treatment begins.

11. The method of claim 1 wherein the load-bearing part is first treated and then introduced to the end termination.

12. A load-bearing part, comprising:
a plurality of tension members;
a polymer material surrounding the plurality of tension members;
wherein the load-bearing part comprises a plurality of sections at least one of which is configured to be inserted into an end termination;
the load-bearing part formed by a process comprising:
selecting at least one section of the load bearing part;
applying a conductive layer to exposed tension members of the at least one section to obtain a connection terminal;
connecting the connection terminal to a monitor; and
connecting the end termination to the monitor.

13. A passenger moving system comprising the load-bearing part of claim 12.

14. The passenger moving system of claim 13, comprising an elevator.
